(19) United States
(12) Patent Application Publication
(10) Pub. No.: US 2026/0316711 A1
(43) Pub. Date: Oct. 15, 2026

(54) TENSIONING DEVICE FOR A SAFETY BELT COMPONENT

(71) Applicant: Autoliv Development AB, Vargarda (SE)

(72) Inventors: Ole SCHARNBERG, Hamburg (DE); Andre LITTMANN, Alveslohe (DE); Dominik JUNGE, Elmshorn (DE)

(21) Appl. No.: 19/109,366

(22) PCT Filed: Sep. 6, 2023
(86) PCT No.: PCT/EP2023/074422

§ 371 Date: Mar. 6, 2025

(30) Foreign Application Priority Data
Sep. 8, 2022 (DE) 10 2022 122 768.5

(51) Int. Cl. B60R 22/195

(52) U.S. Cl. CPC B60R 22/1955; B60R 22/1952

(57) ABSTRACT

A tensioning device for a safety belt component, comprising a gas generator for generating a pressurized gas, a piston which can be driven by the pressurized gas, a tension cable which is connected to the piston and can be connected to the safety belt component to be set into a tightening motion, and a tightening tube for receiving and guiding the piston and a receptacle that accommodates the gas generator.

The present invention relates to a tensioning device for a safety belt component, comprising a gas generator for generating a pressurized gas, a piston which can be driven by the pressurized gas, a tension cable which is connectable to the piston and can be connected to the safety belt component to be set into a tightening motion, a tightening tube for receiving and guiding the piston and a receptacle that accommodates the gas generator.

Such a tensioning device is known, for example, from DE 10 2020 103 157 A1 in which both the receptacle for the gas generator as well as a cable deflection outside the region exposed to the pressurized gas are formed as a single piece in a guide block. A tightening tube is arranged on the guide block, into which the pressurized gas generated by the gas generator enters upon triggering the tensioning device so that the piston arranged in the tightening tube is driven by the pressurized gas. On the side facing away from the tightening tube, the cable deflection formed in one piece in the guide block is shaped in such a way that the tension cable can be guided out of the guide block either in a straight line (if necessary offset parallel) in the direction of movement of the piston, or alternatively can be deflected by 90°or more. In order to change the offset of the tension cable to the direction of movement of the piston or to change the deflection angle with such a design of the guide block, the deflection block must be completely redesigned.

The object of the present invention is therefore that of at least partially eliminating the disadvantages described with respect to the prior art and in particular providing a tensioning device which can more easily be adapted to different requirements.

To achieve the object, it is proposed in particular that the tensioning device has a frame which is arranged on the side facing away from the tightening tube and through which the tension cable runs after it has emerged from a space of the safety belt component which can be acted upon by the pressurized gas. The frame can, for example, be made from a sheet metal which has been formed in particular into a shape with a U-shaped cross-section. The frame serves in particular to accommodate additional components of the tensioning device. In particular, components which serve for cable deflection or cable guidance outside the space exposed to pressurized gas are attached to the frame. The frame can therefore be designed in the same way for different applications of the tensioning device, while the components for deflecting the tension cable can be adapted to different applications (e.g. deflection by 90°or straight passage).

The receptacle for the gas generator is arranged in such a way that the pressurized gas generated by the gas generator enters the tightening tube and drives the piston there. Preferably, the receptacle is arranged in the tightening tube.

In addition, a cable guide can be provided through which the tension cable exits the tightening tube. The cable guide is arranged in a suitable sealing manner in the tightening tube and preferably also provides a seal along the tension cable.

Preferably, both the receptacle for the gas generator as well as the cable guide are arranged completely in the tightening tube.

In order to fix the frame to the tightening tube, it can be provided that the frame can have an engagement portion which, in the mounted state, is arranged within the tightening tube. In this case, it can in particular be provided that the engagement section interacts with the cable guide in the mounted state and additionally fixes it in the tightening tube. The cable guide and the engagement section of the frame can accordingly preferably be fixed simultaneously by pressing the tightening tube.

In a preferred embodiment, it is provided that the receptacle for the gas generator and the cable guide are formed as one piece, wherein the receptacle and the cable guide are arranged completely in the tightening tube.

Preferably, the tightening tube has a section with a circular cross-section in which the piston is arranged and along which the piston is driven by the pressure application. The tightening tube also has a region whose cross-section deviates from a circular cross-section. This region preferably has an oval cross-section. The receptacle and the cable guide are arranged in particular in the region of the tightening tube which deviates in its cross-section from the circular cross-section. The receptacle for the gas generator is arranged and designed in such a way that the pressurized gas generated by the gas generator is introduced directly into the tightening tube and can accordingly reach the piston directly. In particular, the pressurized gas is introduced into a region of the tightening tube in which its cross-sectional design changes. The pressurized gas is therefore not introduced into a space limited by the cable deflection and from there guided to the piston. This allows the pressurized gas to cool down slightly before it comes into direct contact with the tension cable arranged in the tightening tube.

A solution to the object mentioned at the outset is provided in particular with a tensioning device having the features of independent claim 1. Other solutions and advantageous developments of the tensioning device are specified in the description above and in the following as well as in the dependent claims, wherein individual features of the advantageous developments can be combined with one another in a technically sensible manner.

The above-mentioned object is achieved in particular by a tensioning device with the features mentioned at the outset, in which the tension cable extends through a frame on the side facing away from the tensioner tube and in which an end cap is plugged onto the frame, wherein the end cap engages into the frame at least in sections. The end cap is attached to the frame, in particular from the side facing away from the tensioner tube.

In other words: In its basic concepts, the invention provides that an end cap, in particular consisting of a different material (for example plastic), is not only attached to a frame in an overlapping manner, but also has at least one section that engages in the frame, wherein the at least one section engaging in the frame preferably fulfills a function.

For example, it can be provided that the end cap rests against the frame on the inside with a section engaging with the frame and at the same time rests against the outside of the frame with a section extending over the frame on the outside. By placing the end cap on the inside as well as on the outside, a seal is provided so that hot compressed gas which has escaped from the pressure chamber along the cable guide cannot or can only escape with difficulty on the side of the tensioning device covered by the end cap.

In principle, it would be conceivable if the end cap only encompasses the frame sectionally, both inside and outside. In a preferred embodiment, however, it is provided that the end cap closes the frame circumferentially on an end face facing away from the tensioner tube so that the end face covered by the end cap and facing away from the tensioner tube is completely closed. If, for example, the frame is U-shaped in cross-section, the end cap has a U-shaped section engaging into the end cap, while at the same time the end cap has a section extending over the U-shaped frame on the outside that rests against the frame on the outside. The region of the end cap arranged between the U-shaped regions is in particular designed to cover the entire surface so that the end cap completely closes the frame on the side facing away from the tensioner tube.

In addition or as an alternative to the sealing effect of the engaging section, a guide section engaging into the frame can be provided on the end cap and forms a guide for the tension cable. The guide section is designed in such a way that, in the mounted state, the tension cable rests against the guide section. In particular, the guide section has a groove-like recess, the dimensions of which are adapted to the outer circumference of the tension cable. The groove-like recess has a curvature in the direction of the tension cable which determines the deflection of the tension cable, in particular on the outside of the curved tension cable. In particular, the guide section is configured in such a way that the tension cable is deflected by approximately 90°, if necessary in combination with other elements of the tensioning device.

Since the end cap can be easily placed onto and/or into the frame, the end cap can also be exchanged for different purposes of the tensioning device. If, for example, the tension cable is to be guided linearly in the tensioning direction of the piston, the end cap can have a circular opening as a guide section, for example, through which the tension cable is guided out of the frame.

In addition, it can be provided that the section engaging in the frame is designed as a securing section, wherein the frame, the securing section and the tension cable are coordinated with one another in such a way that the tension cable is secured against unintentional movement by the at least one securing section. This is achieved in particular by the securing section, the mounted end cap, coming into contact with the tension cable, thereby applying a force hindering the tension cable in its movement. Without such a force, the tension cable could still move before the final assembly of the tensioning device. On the other hand, the applied force is so low that it does not significantly influence the tightening process.

In one embodiment, it is provided in this regard that the at least one guide section of the end cap engaging into the frame is deformed when inserted into the frame and thereby secures the tension cable against unintentional movement. The at least one securing section is therefore only deformed during insertion and in particular at the end of the insertion process in such a way that a force is exerted on the tension cable to prevent unintentional movement. For this purpose, it can be provided in particular that the frame has corresponding geometric designs along which the securing section is inserted into the frame, wherein the deformation of the securing section takes place due to the geometric designs. Such a deformation is also understood to be a deflection of the securing section.

By the deformation of the securing section, the tension cable can also be pressed against another element of the tensioning device, whereby the tension cable becomes clamped between the securing section and the other element.

In a particularly preferred embodiment, it is provided that two securing sections are provided that engage in the frame, wherein when inserted, the securing sections are deformed from two sides towards the tension cable. This makes it possible for the tension cable to become clamped between the two safety sections.

When designing the sections of the end cap engaging in the frame, it can also be provided that a section physically engaging in the frame has several functions. For example, it can be provided that a part of the section previously described as the guide section serves on the one hand to guide the tension cable and on the other hand rests against the inside of the frame and thus forms an inner sealing section.

The invention and the technical environment are explained below by way of example with reference to the figures. Schematically, in the figures:

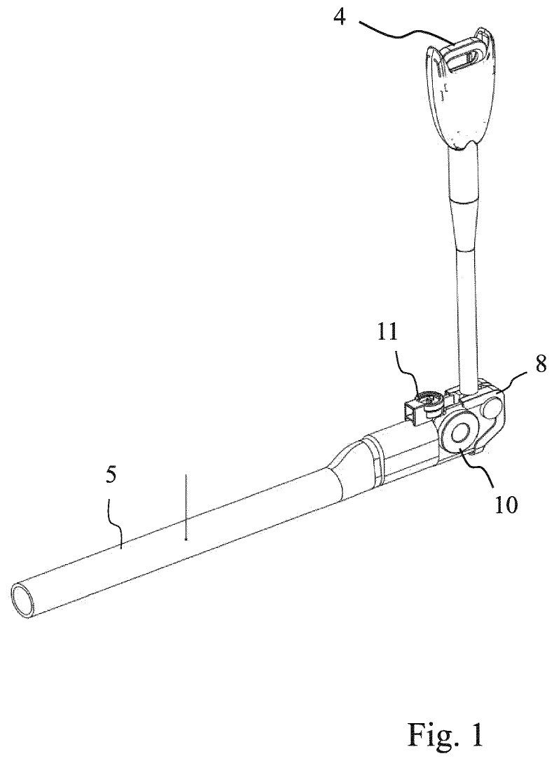

FIG. 1: shows a perspective view of a tensioning device,

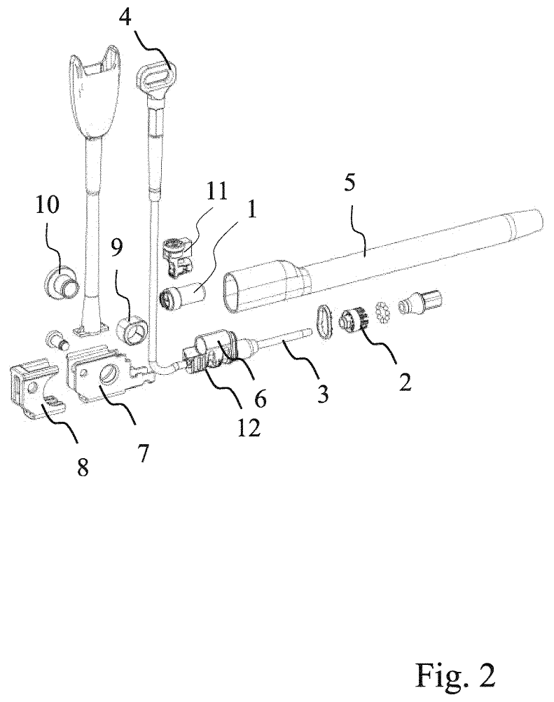

FIG. 2: shows an exploded view of the tensioning device,

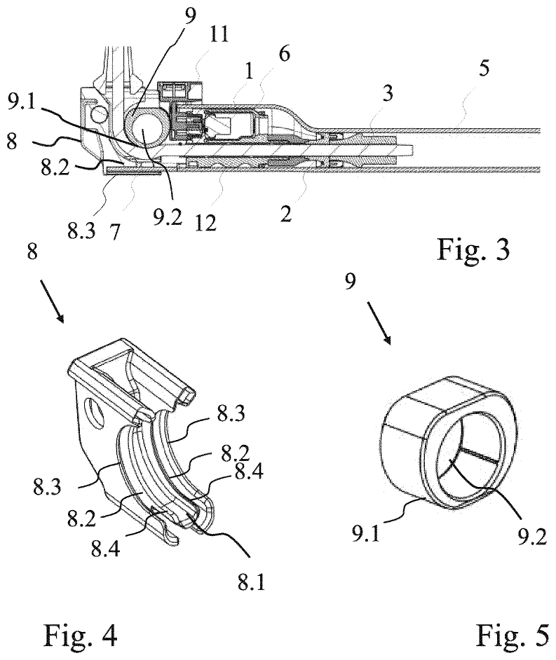

FIG. 3: shows a sectional view through the tensioning device,

FIG. 4: shows a perspective view of an end cap,

FIG. 5: shows a perspective view of a deflection element, and

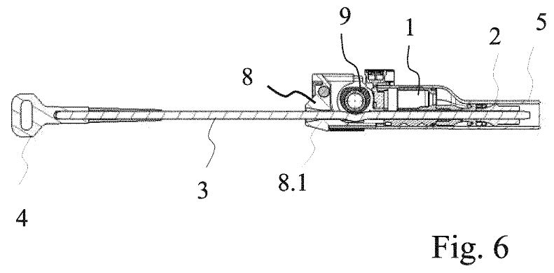

FIG. 6: shows a sectional view through another embodiment of a tensioning device with a straight cable passage.

The tensioning device shown in FIG. 1 to 3 comprises a tightening tube 5 in which a piston rod 2 is arranged in a mounted state. The piston 2 is firmly connected to a tension cable 3 which is inserted into the tightening tube 5 and which is connected on its other side to a safety component 4 to be set into a tightening motion.

The tensioning device also comprises a component in which a cable guide 12 and a receptacle 6 for a gas generator 1 are formed. In the mounted state, this component is arranged in a section of the tightening tube 5 which has an oval-shaped cross-section.

The tensioning device also comprises a frame 7 which, in the mounted state, is arranged with an engagement section within the tightening tube 5.

A deflection element 9 is mounted in the frame 7 by means of a bushing 10, which passes through a receptacle 9.2 of the deflection element 9 in the mounted state and is arranged on both sides of the deflection element 9 in corresponding openings of the frame 7, which is U-shaped in cross section.

The tensioning device also comprises an end cap 8 which is attached to the frame 7 from a side facing away from the tightening tube 5.

As can be seen in particular from FIG. 4, the end cap 8 has several sections which, in the mounted state, are arranged within the frame 7.

Accordingly, the end cap 8 has a guide section 8.1 which is arranged within the frame in the mounted state and which is trough-shaped and has a curvature along the direction of the tension cable.

The end cap 8 also has inner sealing sections 8.2 which, in the mounted state, are arranged on the inside of the frame 7 and bear against the frame 7. At the same time, outer sealing sections 8.3 bear against an outer side of the frame 7. By combining inner sealing sections 8.2 and outer sealing sections 8.3, the frame 7 is sealed on the side facing away from the tightening tube 5 so that pressurized gas escaping from the cable guide 12 cannot escape from the front side of the frame 7, but is deflected.

In addition, the side surfaces of the trough-like guide section 8.1 are designed such that when the end cap 8 is inserted, they are pressed onto the tension cable 3 on both sides by the frame 7, whereby the tension cable 3 is secured against unintentional movement. Accordingly, the end cap 8 forms securing sections 8.4. However, the force exerted by the securing sections 8.4 on the tension cable 3 is not so great that the tightening process is hindered.

As can be seen from FIG. 5, the deflection element 9 has an outer surface referred to as deflection surface 9.1 which has a circular shape in the sectional view shown in FIG. 3. The receptacle 9.2 for the bushing 10 is arranged eccentrically to the deflection surface 9.1 and in particular offset towards the deflection surface 9.1.

The tensioning device also comprises a plug element 11 via which a cable can be connected to the gas generator 1. The outer contour of the plug element 11 is adapted to the outer contour of the deflection element 9.

To initiate a tightening process, the gas generator 1 is ignited, whereby pressurized gas enters the section of the tightening tube 5 with a circular cross-section and drives the piston 2 there along the tightening tube 5. The driven piston 2 sets the safety belt component 4 into a tightening motion, wherein the tension cable 3 is deflected by the deflection element 9 and the guide section 8.1 of the end cap 8.

While in the exemplary embodiment the tension cable 3 is deflected by approximately 90°, the tensioning device can also be adapted by exchanging a few parts so that the tension cable 3 exits the frame 7 in a linear extension of the direction of movement of the piston 2 as shown in FIG. 6.

In the embodiment in FIG. 6, only the end cap 8 has been exchanged for this, wherein the guide section would be designed as an opening through which the tension cable 3 emerges. In order to achieve an optionally different deflection and/or alignment of the tension cable 3, the deflection element 9 can also be designed differently.

With the proposed tensioning device, it can therefore only be adapted to other applications by replacing individual components.

### LIST OF REFERENCE SIGNS

1 Gas generator
2 Piston
3 Tension cable
4 Safety belt component
5 Tensioner tube
6 Receptacle
7 Frame
8 End cap
8.1 Guide section
8.2 Inner sealing section
8.3 Outer sealing section
8.4 Securing section
9 Deflection element
9.1 Deflection surface
9.2 Bushing receptacle
10 Bushing
11 Plug element
12 Cable guide

1. A tensioning device for a safety belt component, having
an inflator for generating a pressurized gas,
a piston that can be driven by the pressurized gas,
a tension cable that is connected to the piston and is connectable to a safety belt component to be put into a tensioning movement,
a tensioner tube for receiving and guiding the piston, and
a receptacle that accommodates the gas generator
wherein
the tension cable extends through a frame on the side facing away from the tensioner tube and that an end cap is plugged onto the frame, wherein the end cap engages into the frame at least in sections.

2. The tensioning device according to claim 1, wherein the end cap abuts at least in sections against an edge of the frame both internally and externally.

3. The tensioning device according to claim 2, wherein the end cap closes the frame circumferentially on an end face facing away from the tensioner tube.

4. The tensioning device according to claim 1, wherein a guide section of the end cap engaging into the frame forms a guide for the tension cable.

5. The tensioning device according to claim 4, wherein the guide section is configured to deflect the tension cable by 90°.

6. The tensioning device according to claim 1, wherein the frame, at least one securing section of the end cap engaging into the frame and the tension cable are aligned with one another in such a way that the tension cable is secured by the at least one securing section against unintentional movement.

7. The tensioning device according to claim 6, wherein the at least one securing portion of the end cap engaging into the frame is deformed when inserted into the frame and thereby secures the tension cable against unintentional movement.

8. The tensioning device according to claim 7, wherein two securing sections of the end cap engaging into the frame are deformed towards the tension cable when inserted from two sides.

9. The tensioning device according to claim 1, wherein the end cap is plugged onto the frame from the end facing away from the tensioner tube.

10. The tensioning device according to claim 1, wherein the frame is formed from a metal sheet and is in particular U-shaped in cross-section.
